(19) United States
(12) Patent Application Publication
(10) Pub. No.: US 2021/0372379 A1
(43) Pub. Date: Dec. 2, 2021

(54) COMPRESSOR

(71) Applicant: Panasonic Intellectual Property Management Co., Ltd., Osaka (JP)

(72) Inventors: TAKAYUKI NAKAUE, Osaka (JP); TAKASHI KAKUWA, Osaka (JP); HIROMI KITA, Nara (JP)

(21) Appl. No.: 17/395,944

(22) Filed: Aug. 6, 2021

Related U.S. Application Data
(63) Continuation of application No. PCT/JP2020/040480, filed on Oct. 28, 2020.

(30) Foreign Application Priority Data
Nov. 26, 2019 (JP) 2019-212864
Oct. 1, 2020 (JP) 2020-166687

(51) Int. Cl. F03G 7/00

(52) U.S. Cl. CPC F03G 7/0254

(57) ABSTRACT

A compressor includes an electrolyte membrane; an anode catalyst layer in contact with a first primary surface of the electrolyte membrane; a cathode catalyst layer in contact with a second primary surface of the electrolyte membrane; an anode diffusion layer disposed on the anode catalyst layer and including a porous carbon sheet; a cathode gas diffusion layer on the cathode catalyst layer; an anode support disposed on the anode diffusion layer and including a metal sheet having a plurality of vent holes; an anode separator disposed on the anode support and having, on the primary surface thereof closer to the anode support, a fluid flow channel through which an anode fluid flows; and a voltage applicator that applies a voltage across the anode catalyst layer and the cathode catalyst layer. The compressor produces compressed hydrogen by causing the voltage applicator to apply the voltage to move extracted protons from an anode fluid supplied to the anode catalyst layer to the cathode catalyst layer via the electrolyte membrane. The flexural strength of the metal sheet is higher than that of the porous carbon sheet.

### BACKGROUND

### 1. Technical Field

The present disclosure relates to a compressor.

### 2. Description of the Related Art

In recent years, hydrogen has been attracting attention as a clean alternative energy source to replace fossil fuels against a background of environmental problems, such as global warming, and energy issues, such as the depletion of petroleum resources. When burnt, basically, hydrogen only releases water, with zero emissions of carbon dioxide, which causes global warming, and almost zero emissions of substances like nitrogen oxides, and this is why hydrogen has been a promising source of clean energy. An example of a device that efficiently uses hydrogen as a fuel is fuel cells. The development and popularization of fuel cells are ongoing for automotive power supply and household power generation applications.

In the forthcoming hydrogen society, technologies will need to be developed to enable not only the production but also high-density storage and small-volume, low-cost transport or use of hydrogen. In particular, further popularization of fuel cells, which provide distributed energy sources, requires preparing an infrastructure for the supply of hydrogen. Various attempts to produce, purify, and densely store high-purity hydrogen are ongoing to ensure stable supply of hydrogen.

For example, Japanese Unexamined Patent Application Publication (Translation of PCT Application) No. 2008-518387 relates to an electrochemical hydrogen pump that pressurizes hydrogen and discloses that its anode gas diffusion layer is formed of a material that has the elasticity and electrical conductivity of carbon fiber.

Japanese Unexamined Patent Application Publication No. 2019-157190 relates to an electrochemical hydrogen pump that pressurizes hydrogen and discloses that its anode gas diffusion layer is a porous piece of metal.

### SUMMARY

One non-limiting and exemplary embodiment provides a compressor that can operate with less damage to a porous carbon sheet in its anode diffusion layer than known ones.

In one general aspect, the techniques disclosed here feature a compressor. The compressor includes an electrolyte membrane; an anode catalyst layer in contact with a first primary surface of the electrolyte membrane; a cathode catalyst layer in contact with a second primary surface of the electrolyte membrane; an anode diffusion layer disposed on the anode catalyst layer and including a porous carbon sheet; a cathode gas diffusion layer on the cathode catalyst layer; an anode support disposed on the anode diffusion layer and including a metal sheet having multiple vent holes; an anode separator disposed on the anode support and having, on a primary surface thereof closer to the anode support, a fluid flow channel through which an anode fluid flows; and a voltage applicator that applies a voltage across the anode catalyst layer and the cathode catalyst layer, the compressor producing compressed hydrogen by causing the voltage applicator to apply the voltage to move extracted protons from an anode fluid supplied to the anode catalyst layer to the cathode catalyst layer via the electrolyte membrane, wherein flexural strength of the metal sheet is higher than flexural strength of the porous carbon sheet.

The compressor according to an aspect of the present disclosure is advantageous in that it can operate with less damage to a porous carbon sheet in its anode diffusion layer than known ones.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a diagram illustrating an example of an electrochemical hydrogen pump according to Embodiment 1;

FIG. 1B is an enlarged view of portion IB of the electrochemical hydrogen pump illustrated in FIG. 1A;

FIG. 2A is a diagram illustrating an example of an electrochemical hydrogen pump in a hydrogen system according to Embodiment 1;

FIG. 2B is an enlarged view of portion IIB of the electrochemical hydrogen pump illustrated in FIG. 2A;

FIGS. 3A to 3C are diagrams illustrating an example of an anode support and an anode separator in an electrochemical hydrogen pump according to Example 2 of Embodiment 1;

FIG. 4 is a diagram illustrating an example of an analytical model in a structural analysis simulation;

FIG. 5A is a diagram illustrating an anode gas diffusion layer in an example analytical model, provided to describe the maximum tensile stress that acts on the anode gas diffusion layer on a vent hole when an external force (compressive force) is given to the anode gas diffusion layer;

FIG. 5B is a diagram illustrating an anode gas diffusion layer in a comparative-example analytical model, provided to describe the maximum tensile stress that acts on the anode gas diffusion layer on an anode gas flow channel when an external force (compressive force) is given to the anode gas diffusion layer;

FIG. 6 is a diagram illustrating an example of an electrochemical hydrogen pump according to Example 4 of Embodiment 1; and

FIG. 7 is a diagram illustrating an example of an anode support and an anode separator in an electrochemical hydrogen pump according to Embodiment 3.

### DETAILED DESCRIPTION

The electrochemical hydrogen pump disclosed in Japanese Unexamined Patent Application Publication No. 2019-157190 uses a porous piece of metal as its anode gas diffusion layer. The anode gas diffusion layer, however, tends to cost much as it needs to be resistant to corrosion under highly acidic conditions.

As for the electrochemical hydrogen pump disclosed in Japanese Unexamined Patent Application Publication (Translation of PCT Application) No. 2008-518387, its anode diffusion layer is a porous piece of carbon formed of carbon fiber. The anode diffusion layer can therefore be rendered resistant to corrosion at a lower cost than when a porous piece of metal is used. After research, however, the inventors found the electrochemical hydrogen pump disclosed in Japanese Unexamined Patent Application Publication (Translation of PCT Application) No. 2008-518387 has the following disadvantage.

Specifically, the inventors noticed the possibility that its anode diffusion layer, including a porous piece of carbon, can be damaged by the differential pressure (high pressure) between the cathode and anode that occurs when the electrochemical hydrogen pump operates to pressurize hydrogen. For example, the anode diffusion layer can break in a gas flow channel in an anode separator because of this differential pressure.

As a solution to this, the inventors conceived of an aspect of the present disclosure as described below.

That is, a compressor according to an aspect of the present disclosure includes an electrolyte membrane; an anode catalyst layer in contact with a first primary surface of the electrolyte membrane; a cathode catalyst layer in contact with a second primary surface of the electrolyte membrane; an anode diffusion layer disposed on the anode catalyst layer and including a porous carbon sheet; a cathode gas diffusion layer on the cathode catalyst layer; an anode support disposed on the anode diffusion layer and including a metal sheet having multiple vent holes; an anode separator disposed on the anode support and having, on a primary surface thereof closer to the anode support, a fluid flow channel through which an anode fluid flows; and a voltage applicator that applies a voltage across the anode catalyst layer and the cathode catalyst layer, the compressor producing compressed hydrogen by causing the voltage applicator to apply the voltage to move extracted protons from an anode fluid supplied to the anode catalyst layer to the cathode catalyst layer via the electrolyte membrane, wherein flexural strength of the metal sheet is higher than flexural strength of the porous carbon sheet.

Configured as such, the compressor according to this aspect can operate with less damage to a porous carbon sheet in its anode diffusion layer than known ones.

If, for example, it is assumed that there is no anode support between the anode diffusion layer and the anode separator, the anode diffusion layer can break in the fluid flow channel in the anode separator because of the pressure difference between the cathode and anode that occurs when the compressor operates to pressurize hydrogen.

The compressor according to this aspect, by contrast, has an anode support between the anode diffusion layer and the anode separator, and the flexural strength of a metal sheet in the anode support is higher than that of a porous carbon sheet in the anode diffusion layer. The risk of damage to the porous carbon sheet from the aforementioned differential pressure is therefore lower.

The porous carbon sheet, furthermore, has relatively few of sharp points that have been observed with the currently used porous piece of metal. Even if such a porous carbon sheet is pressed against the electrolyte membrane, the compressor according to this aspect is at a reduced risk of damage to the electrolyte membrane compared with one made with the currently used porous piece of metal.

In addition, the anode diffusion layer has a pair of primary surfaces, and the anode support including a metal sheet is on the primary surface opposite the one closer to the anode catalyst layer. Whereas the primary surface closer to the anode catalyst layer is under highly acidic conditions because it is the interface with the anode catalyst layer, the opposite primary surface is not under highly acidic conditions because it is apart from the anode catalyst layer. Accordingly, the anode support including a metal sheet does not need to be highly resistant to corrosion and, therefore, costs less.

A compressor according to a second aspect of the present disclosure is: For the compressor according to the first aspect, the air permeance of the anode support along the thickness thereof may be greater than the air permeance of the porous carbon sheet along the thickness thereof.

The greater the air permeance of the anode support along its thickness is, the easier it is to ensure the diffusion of the anode fluid from the anode diffusion layer into the anode catalyst layer. That is, the compressor according to this aspect is prevented well from losing efficiency compared with one that has an anode support between the anode diffusion layer and the anode separator and wherein the air permeance of the anode support along its thickness is smaller than or equal to that of the porous carbon sheet.

A compressor according to a third aspect of the present disclosure is: For the compressor according to the first or second aspect, a subset of the multiple vent holes may straddle an edge of the fluid flow channel.

If it is assumed that a vent hole in the metal sheet in the anode support does not straddle an edge of the fluid flow channel in the anode separator but lies on a rib of the fluid flow channel, this vent hole does not allow the anode fluid through to be supplied to the anode diffusion layer. When the opposite is the case, or when a vent hole in the metal sheet straddles an edge of the fluid flow channel, this vent hole allows the anode fluid through to be supplied to the anode diffusion layer.

Hence the compressor according to this aspect, in which a subset of the multiple vent holes straddle an edge of the fluid flow channel, is improved in terms of the diffusion of the anode fluid from the anode diffusion layer into the anode catalyst layer compared with one wherein the same subset of vent holes does not straddle an edge of the fluid flow channel but lies on rib(s) of the fluid flow channel.

A compressor according to a fourth aspect of the present disclosure is: For the compressor according to any one of the first to third aspects, the size of at least a subset of the multiple vent holes along the transverse axis of the fluid flow channel may be smaller than the width of the fluid flow channel.

A component that supports the anode diffusion layer may have deformable openings, such as holes or such as grooves (recesses) of a fluid flow channel. When an external force (compressive force) is given to the anode diffusion layer in that case, the portions of the anode diffusion layer on the openings are exposed to more stress than the rest (stress concentration). In general, the tensile stress on an anode diffusion layer with holes therebelow peaks near the center of the holes, and this maximum tensile stress increases with increasing diameter of the holes. Likewise, the tensile stress on an anode diffusion layer with a fluid flow channel therebelow peaks near the middle of the width of the fluid flow channel, and this maximum tensile stress increases with increasing width of the fluid flow channel.

As such, the compressor according to this aspect has an anode support between its anode diffusion layer and anode separator, and the relative magnitudes of the size of vent hole(s) and the width of the fluid flow channel are as specified above. By virtue of this, the compressor according to this aspect is unlikely to suffer the situation of the porous carbon sheet in the anode diffusion layer being damaged by the differential pressure between the cathode and anode that occurs when the compressor operates to pressurize hydrogen, compared with one wherein the size of the vent hole(s) is larger than or equal to the width of the fluid flow channel.

A compressor according to a fifth aspect of the present disclosure is: For the compressor according to any one of the first to fourth aspects, the porous carbon sheet may be a sheet of sintered carbon.

In general, sintered carbon is rigid compared with a compact given by mixing a powder of the carbon, for example with a resin, and setting or curing the mixture by drying. In particular, plastic-formed carbon (carbon-graphite composite with a resin) has high flexural strength. Hence, for the compressor according to this aspect, the anode diffusion layer has an appropriate degree of flexural strength if the porous carbon sheet is a sheet of sintered carbon.

A compressor according to a sixth aspect of the present disclosure is: The compressor according to any one of the first to fifth aspects, an electrically conductive layer is disposed on the surface of the anode support.

On the surface of the metal sheet in the anode support, the constituents of the metal sheet may be oxidized, for example by atmospheric oxygen, to form an electrically non-conductive oxide film (passive film). It hinders, for example, the electrical conduction between the anode support and the anode separator by increasing the contact resistance therebetween. Alternatively, it hinders, for example, the electrical conduction between the anode support and the anode diffusion layer by increasing the contact resistance therebetween.

As such, the compressor according to this aspect has an electrically conductive layer on the surface of the anode support. This helps prevent the above-described problem well.

A compressor according to a seventh aspect of the present disclosure is: For the compressor according to any one of the first to sixth aspects, the thickness of the anode diffusion layer may be larger than the thickness of the anode support.

Configured as such, the compressor according to this aspect has a sufficiently long distance between the metal sheet and the anode catalyst layer, the inside of which will be a highly acidic atmosphere, compared with one wherein the thickness of the anode diffusion layer is smaller than that of the anode support. Hence the metal sheet can be an inexpensive, corrosion-vulnerable material.

A compressor according to an eighth aspect of the present disclosure is: For the compressor according to any one of the first to seventh aspects, the metal sheet may be one metal steel plate.

Configured as such, the compressor according to this aspect has a reduced number of components compared with one wherein the metal sheet is formed by multiple metal steel plates. The assembly is therefore streamlined.

A compressor according to a ninth aspect of the present disclosure is: For the compressor according to any one of the first to eighth aspects, the anode support may be integral with the anode separator.

Configured as such, the compressor according to this aspect has a one-piece construction of, for example, the metal sheet in the anode support and the anode separator joined together by diffusion bonding. With no space at the interface between them, the contact resistance therebetween is lower. In addition, the compressor according to this aspect offers streamlined assembly by virtue of the reduced number of components.

A compressor according to a tenth aspect of the present disclosure is: For the compressor according to any one of the first to eighth aspects, the anode support may be integral with the anode diffusion layer.

The integration of the anode support and the anode diffusion layer can be achieved by providing a suitable resin or other material (e.g., an ionomer) therebetween. With this achieved, the compressor according to this aspect offers streamlined assembly by virtue of the reduced number of components.

The following describes embodiments of the present disclosure with reference to the attached drawings. The embodiments described below are all given to illustrate examples of the aspects described above. That is, the shapes, materials, structural elements, the positions of and connections between elements, and other information given below are merely examples and not intended to limit the aspects described above unless given in a claim. Any element mentioned below but not recited in the independent claim, which represents the most generic concept of the aspects described above, is described as being optional. An element assigned the same reference sign in different drawings may be described only once. The drawings are schematic illustrations of structural elements given to help understand and therefore may be inaccurate in the representation of shape, relative dimensions, etc.

### Embodiment 1

The anode fluid in a compressor as described above can be selected from a wide variety of gases and liquids. For example, if the compressor is an electrochemical hydrogen pump, an example of an anode fluid is a hydrogen-containing gas. If the compressor is a water electrolyzer, for example, an example of an anode fluid is liquid water.

The following embodiments therefore describe the structure and operation of an electrochemical hydrogen pump, which is an example of a compressor, assuming the anode fluid is a hydrogen-containing gas.

### Compressor Structure

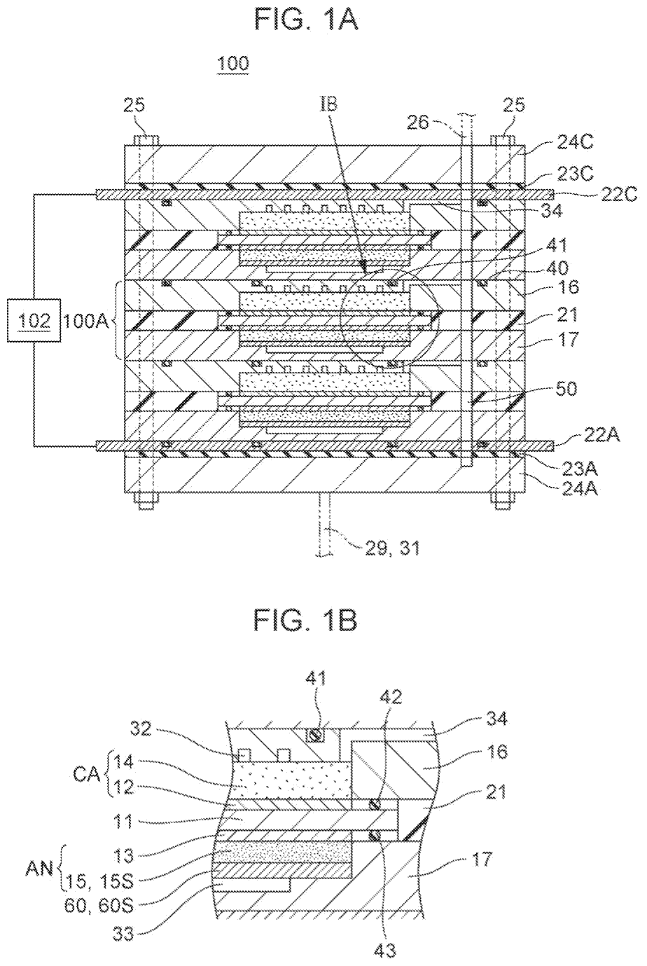

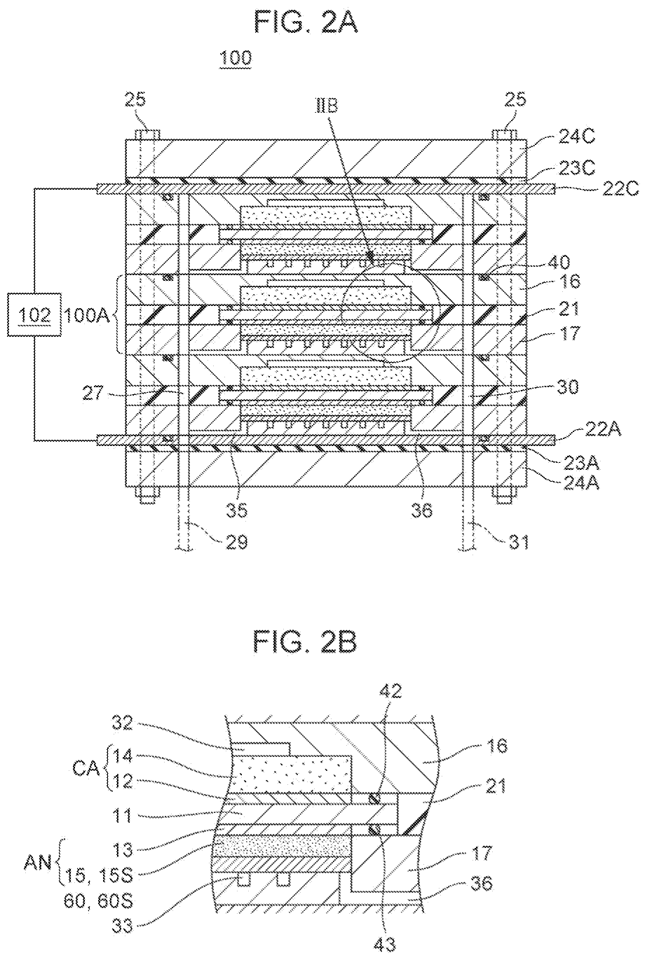

FIGS. 1A and 2A are diagrams illustrating an example of an electrochemical hydrogen pump according to Embodiment 1. FIG. 1B is an enlarged view of portion IB of the electrochemical hydrogen pump illustrated in FIG. 1A. FIG. 2B is an enlarged view of portion IIB of the electrochemical hydrogen pump illustrated in FIG. 2A.

FIG. 1A illustrates a vertical section of an electrochemical hydrogen pump 100 that includes a straight line passing through the center of the electrochemical hydrogen pump 100 and the center of a cathode gas outlet manifold 50 in plan view. FIG. 2A illustrates a vertical section of the electrochemical hydrogen pump 100 that includes a straight line passing through the center of the electrochemical hydrogen pump 100, the center of an anode gas inlet manifold 27, and the center of an anode gas outlet manifold 30 in plan view.

In the example illustrated in FIGS. 1A and 2A, the electrochemical hydrogen pump 100 includes at least one hydrogen pump unit 100A.

The electrochemical hydrogen pump 100 has a stack of multiple hydrogen pump units 100A. For example, in FIGS. 1A and 2A, there is a three-tiered stack of hydrogen pump units 100A. This, however, is not the only possible number of hydrogen pump units 100A. That is, an appropriate number of hydrogen pump units 100A can be used according to the operating conditions, such as the volume of hydrogen the electrochemical hydrogen pump 100 pressurizes.

A hydrogen pump unit 100A includes an electrolyte membrane 11, an anode AN, a cathode CA, an anode support 60, a cathode separator 16, an anode separator 17, and an insulator 21. In a hydrogen pump unit 100A, furthermore, an electrolyte membrane 11, an anode catalyst layer 13, a cathode catalyst layer 12, an anode gas diffusion layer 15, a cathode gas diffusion layer 14, an anode support 60, an anode separator 17, and a cathode separator 16 are stacked together.

The anode AN is on a first primary surface of the electrolyte membrane 11. The anode AN is an electrode that includes an anode catalyst layer 13 and an anode gas diffusion layer 15. There is a ring-shaped seal 43 surrounding the anode catalyst layer 13 in plan view, and the anode catalyst layer 13 is sealed with the seal 43 properly.

The cathode CA is on a second primary surface of the electrolyte membrane 11. The cathode CA is an electrode that includes a cathode catalyst layer 12 and a cathode gas diffusion layer 14. There is a ring-shaped seal 42 surrounding the cathode catalyst layer 12 in plan view, and the cathode catalyst layer 12 is sealed with the seal 42 properly.

As a result of these, the electrolyte membrane 11 is sandwiched between the anode AN and cathode CA to touch each of the anode and cathode catalyst layers 13 and 12. The stack of the cathode CA, electrolyte membrane 11, and anode AN is referred to as a membrane electrode assembly (hereinafter MEA).

The electrolyte membrane 11 is a proton-conductive polymer film. The electrolyte membrane 11 can be of any type as long as it is proton-conductive. Examples of electrolyte membranes 11 include, but are not limited to, a fluoropolymer electrolyte membrane and a hydrocarbon polymer electrolyte membrane. Specifically, the electrolyte membrane 11 can be, for example, Nafion® (DuPont) or Aciplex® (Asahi Kasei Corporation).

The anode catalyst layer 13 is on the first primary surface of the electrolyte membrane 11, touching it. The anode catalyst layer 13 contains platinum as a catalyst metal, but this is not the only possibility.

The cathode catalyst layer 12 is on the second primary surface of the electrolyte membrane 11, touching it. The cathode catalyst layer 12 contains platinum as a catalyst metal, but this is not the only possibility.

Examples of catalyst carriers for the cathode and anode catalyst layers 12 and 13 include, but are not limited to, carbon particles, for example of carbon black or graphite, and electrically conductive oxide particles.

In the cathode and anode catalyst layers 12 and 13, fine particles of catalyst metal are held on a catalyst carrier in a highly dispersed state. Usually, these cathode and anode catalyst layers 12 and 13 contain a proton-conductive ionomer component added to expand the field for electrode reactions.

The cathode gas diffusion layer 14 is on the cathode catalyst layer 12. The cathode gas diffusion layer 14 is a layer of porous material, is electrically conductive, and allows gases to diffuse therethrough. Desirably, the cathode gas diffusion layer 14 is elastic so that it will smoothly follow the displacement and deformation of structural components that occur because of the differential pressure between the cathode CA and anode AN when the electrochemical hydrogen pump 100 operates. The electrochemical hydrogen pump 100 according to this embodiment uses a carbon fiber element as its cathode gas diffusion layer 14. For example, the cathode gas diffusion layer 14 may be a porous carbon fiber sheet, such as a piece of carbon paper, carbon cloth, or carbon felt. The base material for the cathode gas diffusion layer 14, however, does not need to be a carbon fiber sheet. For example, the base material for the cathode gas diffusion layer 14 may be a sintered mass of metal fibers, for example of titanium, a titanium alloy, or stainless steel, a sintered mass of particles of any such metal, etc.

The anode gas diffusion layer 15 is on the anode catalyst layer 13. The anode gas diffusion layer 15 is a layer of porous material, is electrically conductive, and allows gases to diffuse therethrough. Desirably, the anode gas diffusion layer 15 is highly rigid so that it will limit the displacement and deformation of structural components that occur because of the differential pressure between the cathode CA and anode AN when the electrochemical hydrogen pump 100 operates.

Specifically, the anode gas diffusion layer 15 is a layer that includes a porous carbon sheet 15S. The porous carbon sheet 15S can be, for example, a sintered mass of carbon particles.

The anode support 60 is an element disposed on the anode gas diffusion layer 15 and including a metal sheet 60S having multiple vent holes (not illustrated in FIGS. 1A and 1B). Desirably, the metal sheet 60S in the anode support 60 has a higher flexural strength than the porous carbon sheet 15S in the anode gas diffusion layer 15 so that it will not be destroyed by the differential pressure between the cathode CA and anode AN when the electrochemical hydrogen pump 100 operates. Desirably, the anode support 60 is highly rigid so that it will limit the displacement and deformation of structural components caused by the differential pressure.

Here, in bending testing, a tensile fracture occurs first. In general, therefore, flexural strength is equivalent to tensile strength. The flexural strength of the metal sheet 60S can therefore be determined by Metallic materials-Tensile testing—Method of test at room temperature, JIS Z2241: 2011 standard.

The flexural strength of the porous carbon sheet 15S can be determined by Testing method for flexural strength (modulus of rupture) of fine ceramics at room temperature, JIS R1601: 2008 standard.

For example, for the electrochemical hydrogen pump 100 according to this embodiment, the flexural strength of an SUS316L metal sheet 60S may be 480 MPa or more, and that of the porous carbon sheet 15S may be 48 MPa or more.

Such a metal sheet 60S can be, for example, a piece of punched metal. The hole pattern, such as the shape and arrangement of the vent holes, of the metal sheet 60S is described in Example 2.

Desirably, the thickness of the porous carbon sheet 15S is larger than that of the metal sheet 60S. For example, it is desirable that the thickness of the porous carbon sheet 15S be larger than or equal to 1.5 times that of the metal sheet 60S. When this is the case, the distance between the metal sheet 60S and the anode catalyst layer 13, the inside of which will be a highly acidic atmosphere, is sufficiently long compared with that when the thickness of the porous carbon sheet 15S is smaller than that of the metal sheet 60S; hence, the metal sheet 60S can be an inexpensive, corrosion-vulnerable material.

The metal sheet 60S as described above may be made of a metal such as titanium or stainless steel, but these are not the only possibilities. If a stainless-steel metal sheet 60S is used, SUS316 and SUS316L, among many types of stainless steel, are of good quality for their price; they have good characteristics, for example in terms of acid resistance and resistance to hydrogen embrittlement.

The metal sheet 60S as described above, furthermore, may be one metal steel plate. When this is the case, the assembly is streamlined by virtue of the reduced number of components compared with that when the metal sheet 60S is formed by multiple metal steel plates.

The anode separator 17 is an element disposed on the anode support 60 and having an anode gas flow channel 33, through which the hydrogen-containing gas flows, in its primary surface closer to the anode support 60. The cathode separator 16 is an element disposed on the cathode CA and having a cathode gas flow channel 32, through which the hydrogen-containing gas flows, in its primary surface closer to the cathode CA.

The anode and cathode separators 17 and 16 as described above may be made of, for example, a metal such as titanium or stainless steel. That is, the base material for the metal sheet 60S and those for the anode and cathode separators 17 and 16 may be the same. If stainless-steel anode and cathode separators 17 and 16 are used, SUS316 and SUS316L, among many types of stainless steel, are of good quality for their price; they have good characteristics, for example in terms of acid resistance and resistance to hydrogen embrittlement.

In the middle of each of the cathode and anode separators 16 and 17 is a recess. The recess in the cathode separator 16 contains the cathode gas diffusion layer 14, and that in the anode separator 17 contains the anode gas diffusion layer 15 and the anode support 60.

In such a way, an MEA as described above is sandwiched between cathode and anode separators 16 and 17, forming a hydrogen pump unit 100A.

The anode gas and cathode gas flow channels 33 and 32 may each be, for example, a serpentine flow channel, which includes multiple U-shaped turns and multiple straight stretches, in plan view. In the illustrated example, the straight stretches of the cathode gas flow channel 32 extend perpendicular to the plane of the page of FIG. 1A, and those of the anode gas flow channel 33 extends perpendicular to the plane of the page of FIG. 2A.

The anode and cathode gas flow channels 33 and 32 as described above, however, are by way of example and are not the only possibility. For example, the anode and cathode gas flow channels may be formed by multiple linear passages. A serpentine cathode gas flow channel, furthermore, is optional. A simple through hole that connects the inside and outside of the recess in the cathode separator would allow the high-pressure gas to be released out of the cathode CA.

If the cathode and anode separators 16 and 17 are electrically conductive, furthermore, there may be a ring-shaped flat-plate insulator 21 interposed therebetween, surrounding the edge of the MEA. This helps prevent short-circuiting between the cathode and anode separators 16 and 17 well.

The electrochemical hydrogen pump 100 includes first and second end plates, which are at the ends in the direction of stacking of the hydrogen pump units 100A, and fasteners 25, with which the hydrogen pump units 100A, first end plate, and second end plate are fastened together in the direction of stacking.

In the example illustrated in FIGS. 1A and 2A, a cathode end plate 24C and an anode end plate 24A correspond to these first and second end plates, respectively. That is, the anode end plate 24A is an end plate on the anode separator 17 located at a first end in the direction of stacking of the components of the hydrogen pump units 100A. The cathode end plate 24C is an end plate on the cathode separator 16 located at a second end in the direction of stacking of the components of the hydrogen pump units 100A.

The fasteners 25 can be of any type as long as the hydrogen pump units 100A, cathode end plate 24C, and anode end plate 24A can be fastened together in the direction of stacking therewith.

For example, the fasteners 25 can be bolts and Belleville washer nuts or a similar tool.

In that case, the bolts of the fasteners 25 may be made to penetrate only through the anode and cathode end plates 24A and 24C. For the electrochemical hydrogen pump 100 according to this embodiment, however, the bolts penetrate through the components of the three-tiered stack of hydrogen pump units 100A, a cathode feed plate 22C, a cathode insulating plate 23C, an anode feed plate 22A, an anode insulating plate 23A, the anode end plate 24A, and the cathode end plate 24C. The fasteners 25 apply the desired fastening pressure to the hydrogen pump units 100A by compressing the end surface of the cathode separator 16 at the second end in the aforementioned direction of stacking and that of the anode separator 17 at the first end in the aforementioned direction of stacking with the cathode and anode end plates 24C and 24A, respectively, with the cathode feed plate 22C and insulating plate 23C and the anode feed plate 22A and insulating plate 23A interposed therebetween.

As a result of these, the electrochemical hydrogen pump 100 according to this embodiment holds its three-tiered stack of hydrogen pump units 100A stacked properly in the aforementioned direction of stacking by virtue of fastening pressure of fasteners 25. Since the bolts of the fasteners 25 penetrate through the components of the electrochemical hydrogen pump 100, furthermore, in-plane movement of these components is restrained properly.

Here, for the electrochemical hydrogen pump 100 according to this embodiment, the cathode gas flow channel 32, through which hydrogen (H₂)-containing cathode gas (hereinafter, hydrogen) coming out of the cathode gas diffusion layer 14 of each individual hydrogen pump unit 100A flows, communicates with one another. In the following, how each cathode gas flow channel 32 communicates is described with reference to drawings.

First, as illustrated in FIG. 1A, the cathode gas outlet manifold 50 is a series of through holes created through the components of the three-tiered stack of hydrogen pump units 100A and the cathode end plate 24C and a blind hole created into the anode end plate 24A. The cathode end plate 24C also has a cathode gas outlet line 26. The cathode gas outlet line 26 may be piping through which hydrogen discharged from the cathodes CA flows. The cathode gas outlet line 26 communicates with the cathode gas outlet manifold 50.

The cathode gas outlet manifold 50, furthermore, communicates with one end of the cathode gas flow channel 32 of each individual hydrogen pump unit 100A via separate cathode gas conduits 34. By virtue of this, streams of hydrogen that have passed through the cathode gas flow channel 32 and cathode gas conduit 34 of each individual hydrogen pump unit 100A are combined together at the cathode gas outlet manifold 50. The combined stream of hydrogen is then guided to the cathode gas outlet line 26.

In such a way, the cathode gas flow channel 32 of each individual hydrogen pump unit 100A communicates with one another via the cathode gas conduit 34 of each individual hydrogen pump unit 100A and the cathode gas outlet manifold 50.

Between cathode and anode separators 16 and 17, a cathode separator 16 and the cathode feed plate 22C, and an anode separator 17 and the anode feed plate 22A, there are ring-shaped seals 40, such as O-rings, surrounding the cathode gas outlet manifold 50 in plan view. The cathode gas outlet manifold 50 is sealed with these seals 40 properly.

As illustrated in FIG. 2A, the anode end plate 24A has an anode gas inlet line 29. The anode gas inlet line 29 may be piping through which the hydrogen-containing gas to be supplied to the anodes AN flows. The anode gas inlet line 29 communicates with a tubular anode gas inlet manifold 27. The anode gas inlet manifold 27 is a series of through holes created through the components of the three-tiered stack of hydrogen pump units 100A and the anode end plate 24A.

The anode gas inlet manifold 27 communicates with a first end of the anode gas flow channel 33 of each individual hydrogen pump unit 100A via separate first anode gas conduits 35. By virtue of this, the hydrogen-containing gas supplied from the anode gas inlet line 29 to the anode gas inlet manifold 27 is distributed to each individual hydrogen pump unit 100A through the first anode gas conduit 35 of each individual hydrogen pump unit 100A. While passing through the anode gas flow channel 33, the distributed hydrogen-containing gas is supplied to the anode catalyst layer 13 through the anode gas diffusion layer 15.

As illustrated in FIG. 2A, furthermore, the anode end plate 24A has an anode gas outlet line 31. The anode gas outlet line 31 may be piping through which the hydrogen-containing gas discharged from the anodes AN flows. The anode gas outlet line 31 communicates with a tubular anode gas outlet manifold 30. The anode gas outlet manifold 30 is a series of through holes created through the components of the three-tiered stack of hydrogen pump units 100A and the anode end plate 24A.

The anode gas outlet manifold 30 communicates with a second end of the anode gas flow channel 33 of each individual hydrogen pump unit 100A via separate second anode gas conduits 36. By virtue of this, streams of the hydrogen-containing gas that have passed through the anode gas flow channel 33 of each individual hydrogen pump unit 100A are supplied to the anode gas outlet manifold 30, and combined together there, through each individual second anode gas conduit 36. The combined stream of the hydrogen-containing gas is then guided to the anode gas outlet line 31.

Between cathode and anode separators 16 and 17, a cathode separator 16 and the cathode feed plate 22C, and an anode separator 17 and the anode feed plate 22A, there are ring-shaped seals 40, such as O-rings, surrounding the anode gas inlet and outlet manifolds 27 and 30 in plan view. The anode gas inlet and outlet manifolds 27 and 30 are sealed with these seals 40 properly.

As illustrated in FIGS. 1A and 2A, the electrochemical hydrogen pump 100 includes a voltage applicator 102.

The voltage applicator 102 is a device that applies a voltage across the anode and cathode catalyst layers 13 and 12. Specifically, the high potential of the voltage applicator 102 has been applied to the anode catalyst layer 13, and the low potential of the voltage applicator 102 has been applied to the cathode catalyst layer 12. The voltage applicator 102 can be of any type as long as a voltage can be applied across the anode and cathode catalyst layers 13 and 12 therewith. For example, the voltage applicator 102 may be a device that controls the voltage applied across the anode and cathode catalyst layers 13 and 12. In that case, the voltage applicator 102 is equipped with a DC-to-DC converter if it is connected to a direct-current power supply, such as a battery, solar cell, or fuel cell, or with an AC-to-DC converter if it is connected to an alternating-current power supply, such as mains electricity.

Alternatively, the voltage applicator 102 may be, for example, a multi-range power supply, with which the voltage applied across the anode and cathode catalyst layers 13 and 12 and the current that flows between the anode and cathode catalyst layers 13 and 12 are controlled so that the amount of electricity supplied to the hydrogen pump units 100A will match a particular preset value.

In the example illustrated in FIGS. 1A and 2A, the low-potential terminal of the voltage applicator 102 is connected to the cathode feed plate 22C, and the high-potential terminal of the voltage applicator 102 is connected to the anode feed plate 22A. The cathode feed plate 22C is in electrical contact with the cathode separator 16 located at the second end in the aforementioned direction of stacking, and the anode feed plate 22A is in electrical contact with the anode separator 17 located at the first end in the aforementioned direction of stacking.

In such away, the electrochemical hydrogen pump 100 produces compressed hydrogen by causing the voltage applicator 102 to apply the aforementioned voltage to move extracted protons from a hydrogen-containing gas supplied to the anode catalyst layer 13 to move the protons to the cathode catalyst layer 12 through the electrolyte membrane 11.

Although not illustrated, a hydrogen supply system that includes this electrochemical hydrogen pump 100 can also be built. In that case, the hydrogen supply system is equipped as necessary for its operation of supplying hydrogen.

For example, the hydrogen supply system may be fitted with a dew-point controller (e.g., a humidifier) that controls the dew point of the mixed gas produced by the mixing together of the heavily humidified hydrogen-containing gas discharged from the anodes AN through the anode gas outlet line 31 and an only slightly humidified hydrogen-containing gas supplied from an external hydrogen source through the anode gas inlet line 29. In that case, the hydrogen-containing gas from an external hydrogen source may be produced using, for example, a water electrolyzer.

Alternatively, the hydrogen supply system may be fitted with, for example, a temperature sensor that detects the temperature of the electrochemical hydrogen pump 100, a hydrogen reservoir that provides a temporary storage for hydrogen discharged from the cathodes CA of the electrochemical hydrogen pump 100, and a pressure sensor that detects the pressure of hydrogen gas inside the hydrogen reservoir.

It should be noted that the above-described structure of the electrochemical hydrogen pump 100 and various equipment, not illustrated, for a hydrogen supply system are by way of example and are not the only possibilities.

For example, the electrochemical hydrogen pump 100 may have a dead-end structure, in which the pump 100 has no anode gas outlet manifold 30 and no anode gas outlet line 31, and all hydrogen in the anode gas supplied to the anodes AN through the anode gas inlet manifold 27 is pressurized at the cathodes CA.

### Operation

In the following, an example of how the electrochemical hydrogen pump 100 operates to pressurize hydrogen is described with reference to drawings.

The following operation may be carried out as a result of, for example, the processor of a controller, not illustrated, reading a control program stored in a data storage in the controller. The involvement of a controller in this operation, however, is optional. The person who operates the pump 100 may undertake part of the operation.

First, a low-pressure hydrogen-containing gas is supplied to the anodes AN of the electrochemical hydrogen pump 100, and a voltage from the voltage applicator 102 is fed to the electrochemical hydrogen pump 100 at the same time.

At the anode catalyst layer 13 in the anodes AN, hydrogen molecules dissociate into protons and electrons through oxidation (formula (1)). The protons move to the cathode catalyst layer 12 by traveling through the inside of the electrolyte membrane 11. The electrons move to the cathode catalyst layer 12 through the voltage applicator 102.

Then, at the cathode catalyst layer 12, hydrogen molecules are regenerated through reduction (formula (2)). As known, while protons travel through the inside of an electrolyte membrane 11, a particular amount of water moves together with the protons from the anode AN to the cathode CA as electroosmotic water.

During this, the hydrogen (H₂) produced at the cathodes CA can be pressurized by increasing the pressure drop in a hydrogen outlet line using a flow controller, not illustrated. An example of a hydrogen outlet line is the cathode gas outlet line 26 illustrated in FIG. 1A. An example of a flow controller is a back pressure valve, regulator valve, or similar device installed in the hydrogen outlet line.

Anode: H₂ (low pressure)→2H⁺+2e⁻ (1)

Cathode: 2H⁺+2e⁻→H₂ (high pressure) (2)

In such a way, the electrochemical hydrogen pump 100 pressurizes, at the cathodes CA, hydrogen in the hydrogen-containing gas supplied to the anodes AN through the application of a voltage with the voltage applicator 102. This is the hydrogen pressurization by the electrochemical hydrogen pump 100, and the hydrogen pressurized at the cathodes CA is, for example, stored temporarily in a hydrogen reservoir, not illustrated. The hydrogen stored in the hydrogen reservoir is supplied when needed to an entity that requires hydrogen. An example of an entity that requires hydrogen is a fuel cell that uses hydrogen to generate electricity.

Overall, the electrochemical hydrogen pump 100 according to this embodiment can operate with less damage to a porous carbon sheet 15S in its anode gas diffusion layer 15 than known ones.

If, for example, it is assumed that there is no anode support 60 between the anode gas diffusion layer 15 and the anode separator 17, the anode gas diffusion layer 15 can break in the anode gas flow channel 33 in the anode separator 17 because of the pressure difference between the cathode CA and anode AN that occurs when the electrochemical hydrogen pump 100 operates to pressurize hydrogen.

The electrochemical hydrogen pump 100 according to this embodiment, by contrast, has an anode support 60 between the anode gas diffusion layer 15 and the anode separator 17, and the strength of a metal sheet 60S in the anode support 60 is higher than that of a porous carbon sheet 15S in the anode gas diffusion layer 15. The risk of damage to the porous carbon sheet 15S from the aforementioned pressure difference is therefore lower.

The porous carbon sheet 15S, furthermore, has relatively few of sharp points that have been observed with a porous metal sheet, which has hitherto been used as the anode gas diffusion layer. Even if such a porous carbon sheet 15S is pressed against the electrolyte membrane 11, the electrochemical hydrogen pump 100 according to this embodiment is at a reduced risk of damage to the electrolyte membrane 11 compared with one made with the currently used porous metal sheet.

### Example 1

An electrochemical hydrogen pump 100 according to Example 1 is the same as the electrochemical hydrogen pump 100 according to Embodiment 1 except that the air permeance of the anode support 60 along its thickness is greater than that of the porous carbon sheet 15S.

As mentioned herein, air permeance refers to Gurley seconds (or, in other words, air resistance) and is expressed as the length of time a specified volume of air requires to pass through the subject of measurement, per unit area and unit pressure difference. That is, the smaller this value is, the more permeable to air the subject of measurement is. An example of a method for measuring air permeance is one based on JIS P8177 standard.

As can be seen from this, the greater the air permeance of the anode support 60 along its thickness is, the easier it is to ensure the diffusion of the hydrogen-containing gas from the anode gas diffusion layer 15 to the anode catalyst layer 13. That is, the electrochemical hydrogen pump 100 according to this example is prevented well from losing efficiency compared with one that has an anode support 60 between the anode gas diffusion layer 15 and the anode separator 17 and wherein the air permeance of the anode support 60 along its thickness is smaller than or equal to that of the porous carbon sheet 15S.

Except for the described features, the electrochemical hydrogen pump 100 according to this example may be the same as the electrochemical hydrogen pump 100 according to Embodiment 1.

### Example 2

An electrochemical hydrogen pump 100 according to Example 2 is the same as the electrochemical hydrogen pump 100 according to Embodiment 1 except for the structure of the anode support 60 and the anode separator 17, which is described below.

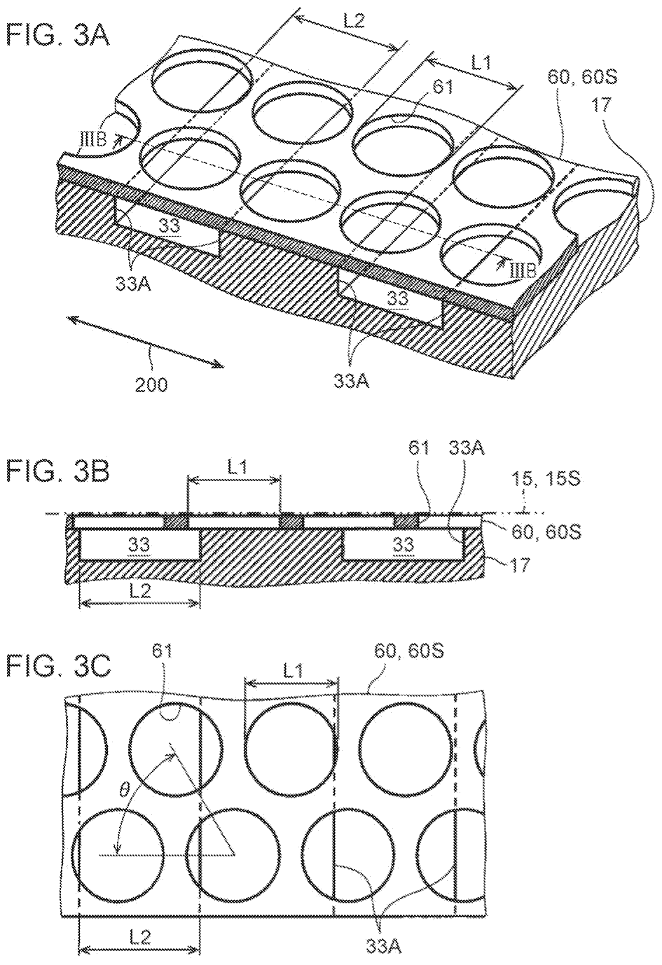

FIGS. 3A to 3C are diagrams illustrating an example of an anode support and an anode separator in an electrochemical hydrogen pump according to Example 2 of Embodiment 1. FIG. 3A illustrates a perspective view of the metal sheet 60S in the anode support 60 and of the anode separator 17. FIG. 3B illustrates a cross-sectional view of portion IIIB-IIIB of FIG. 3A. FIG. 3C illustrates a plan view of the metal sheet 60S in the anode support 60 illustrated in FIG. 3A.

As stated, the metal sheet 60S is a metal element having multiple vent holes 61.

Here, the multiple vent holes can be in any shape. Examples of shapes of the vent holes include, but are not limited to, circles, ovals, a track shape, in which the holes are formed by a pair of straight lines and a pair of semicircles, rectangles, and triangles.

Circular vent holes 61 as illustrated in FIGS. 3A to 3C, however, help limit the stress concentration at the portions of the anode gas diffusion layer 15 on the vent holes 61 that occurs because of the differential pressure between the cathode CA and the anode AN when the electrochemical hydrogen pump 100 operates to pressurize hydrogen, compared with vent holes of the same area in another shape.

The arrangement of the multiple vent holes 61, furthermore, is not critical either. Examples of arrangements of the multiple vent holes 61 include, but are not limited to, a staggered arrangement in which the angle θ between two lines connecting the center of two adjacent vent holes 61 is 60° (60° staggered pattern), a staggered arrangement in which the angle θ is 45° (45° staggered pattern), and the parallel arrangement, in which the angle θ is 90°.

Arranging the multiple vent holes 61 in the 60° staggered pattern (θ=60°) as illustrated in FIG. 3C, however, leads to the largest vent hole 61 coverage per unit area compared with arranging them in any other configuration. In this case, therefore, it is easier to ensure the diffusion of the hydrogen-containing gas from the anode gas diffusion layer 15 to the anode catalyst layer 13.

Examples of methods for making the vent holes 61 in the metal sheet include, but are not limited to, punching, laser machining, and etching.

Perforating the metal sheet by etching, however, is advantageous because etching is less likely to cause the warpage, for example, of the metal sheet than other methods.

When the metal sheet is perforated, the holes may be created to have a tapered cross-section or may be prevented from becoming tapered, for example by perforating the metal sheet from both sides.

Here, for the electrochemical hydrogen pump 100 according to this example, a subset of the multiple vent holes 61 straddles an edge 33A of the anode gas flow channel 33 in the anode separator 17 as illustrated in FIGS. 3A to 3C.

“A subset of the multiple vent holes 61 straddles an edge 33A of the anode gas flow channel 33 in the anode separator 17” means at least a subset of the multiple vent holes 61 straddles an edge 33A of the anode gas flow channel 33. For example, a subset of the multiple vent holes 61 may be present on a groove of the anode gas flow channel 33 rather than straddling an edge 33A of the anode gas flow channel 33.

For the electrochemical hydrogen pump 100 according to this example, furthermore, the size L1 of at least a subset of the multiple vent holes 61 along the transverse axis 200 of the anode gas flow channel 33 in the anode separator 17 is smaller than the width L2 of the anode gas flow channel 33 (L1<L2) as illustrated in FIGS. 3A to 3C. That is, when the straight-stretch portion of a serpentine anode gas flow channel 33 is cut vertically, the primary surface of the anode separator 17 closer to the anode support 60 has multiple protrusions and depressions along the transverse axis 200 of the anode gas flow channel 33. Of these, the depressions are grooves of the anode gas flow channel 33, and the protrusions are ribs of the anode gas flow channel 33.

“The size L1 of at least a subset of the multiple vent holes 61 along the transverse axis of the anode gas flow channel 33 in the anode separator 17” is the average size of the vent holes 61 if the subset consists of multiple vent holes 61.

### Structural Analysis Simulation

When an anode gas diffusion layer with openings therebelow is given an external force (compressive force), stress concentrates at the portions of the anode gas diffusion layer on the openings. This phenomenon of stress concentration was digitized by the following structural analysis simulation. The analytical software is not described; various known analytical software (e.g., ANSYS's Workbench) can be used to carry out structural analysis simulation.

### Analytical Models

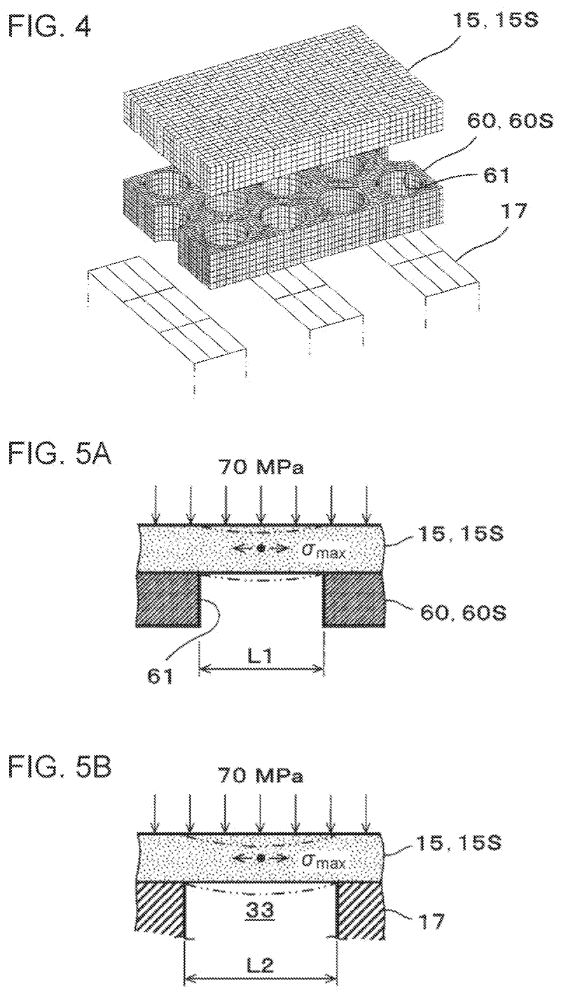

As an example analytical model, an anode gas diffusion layer 15 (porous carbon sheet 15S), an anode support 60 (metal sheet 60S), and ribs of an anode gas flow channel 33 in an anode separator 17 were each simulated (modeled by meshing) on a computer as illustrated in FIG. 4.

Likewise, as a comparative-example analytical model, an anode gas diffusion layer 15 and ribs of an anode gas flow channel 33 in an anode separator 17 were simulated (modeled by meshing) on a computer, although not illustrated. That is, the construction of the comparative-example analytical model omitted modeling of the anode support 60 in the example analytical model.

In the example analytical model, the anode gas diffusion layer 15 and the anode support 60 were modeled to have a thickness of 0.25 mm and 0.3 mm, respectively. The multiple vent holes 61 in the anode support 60 were modeled to be arranged as in FIGS. 3A to 3C in relation to the ribs of the anode gas flow channel 33. That is, along the transverse axis 200 of the anode gas flow channel 33, the size L1 of the vent holes 61 was smaller than the width L2 of the anode gas flow channel 33 (L1<L2), and in plan view, multiple circular vent holes 61 were in the 60° staggered pattern with at least a subset of the vent holes 61 straddling an edge 33A of the anode gas flow channel 33.

### Analytical Parameters

In each of the example and comparative-example analytical models, the computational cells (mesh cells) corresponding to the “anode gas diffusion layer 15” were given the following values as physical characteristics parameters. These values were given assuming the physical characteristics of a typical carbon-made gas diffusion layer (e.g., a porosity of approximately 24.4%).

Young's modulus E: 12.63 GPa

Poisson's ratio ν: 0.17

The computational cells corresponding to the “anode support 60” and the “ribs of the anode gas flow channel 33” in the example analytical model and those corresponding to the “ribs of the anode gas flow channel 33” in the comparative-example analytical model were given the physical characteristics parameters of typical stainless steel.

In addition, as a load parameter for the example and comparative-example analytical models, a uniform compressive stress of 70 MPa was given to each boundary of the computational cells corresponding to the surface of contact between the anode gas diffusion layer 15 and the anode catalyst layer 13. This compressive stress was given assuming the maximum pressure difference between the cathode CA and anode AN of the electrochemical hydrogen pump 100 is, for example, approximately 70 MPa.

These analytical models and analytical parameters are by way of example and are not the only possibilities.

### Analytical Results

FIG. 5A is a diagram illustrating the anode gas diffusion layer in the example analytical model, provided to describe the maximum tensile stress that acts on the anode gas diffusion layer on a vent hole when an external force (compressive force) is given to the anode gas diffusion layer. FIG. 5B is a diagram illustrating the anode gas diffusion layer in the comparative-example analytical model, provided to describe the maximum tensile stress that acts on the anode gas diffusion layer on the anode gas flow channel when an external force (compressive force) is given to the anode gas diffusion layer.

A component that supports the anode gas diffusion layer 15 may have deformable openings, such as holes or such as grooves (recesses) of a gas flow channel. When an external force (compressive force) is given to the anode gas diffusion layer 15 in that case, the portions of the anode gas diffusion layer 15 on the openings are exposed to more stress than the rest (stress concentration).

In general, the tensile stress on an anode gas diffusion layer 15 with holes therebelow peaks near the center of the holes, and this maximum tensile stress σₘₐₓ increases with increasing diameter of the holes. Likewise, the tensile stress on an anode gas diffusion layer 15 with a gas flow channel therebelow peaks near the middle of the width of the gas flow channel, and this maximum tensile stress σₘₐₓ increases with increasing width of the gas flow channel.

As such, the maximum tensile stress σₘₐₓ on an anode gas diffusion layer 15 on a vent hole 61 was calculated in the example analytical model as illustrated in FIG. 5A. σₘₐₓ was approximately 35 MPa. It should be noted that the example analytical model was made with multiple vent holes 61 as illustrated in FIG. 4. On all of these vent holes 61, however, the maximum tensile stress σₘₐₓ was almost equal.

Likewise, the maximum tensile stress σₘₐₓ on an anode gas diffusion layer 15 on an anode gas flow channel 33 was calculated in the comparative-example analytical model as illustrated in FIG. 5B. σₘₐₓ was approximately 154 MPa.

As can be seen from this, when a comparison was made between the case with an anode support 60 between the anode gas diffusion layer 15 and the anode separator 17 and the case without an anode support 60, the tensile maximum stress σₘₐₓ in the latter case was approximately 4.4 times that in the former case.

In addition, given that the fracture strength of a typical carbon-made gas diffusion layer (e.g., a porosity of approximately 24.4%) is approximately 48 MPa, omitting an anode support 60 between the anode gas diffusion layer 15 and the anode separator 17 can cause the porous carbon sheet 15S in the anode gas diffusion layer 15 to break in the anode gas flow channel 33 because of the differential pressure that occurs between the cathodes CA and anodes AN of the electrochemical hydrogen pump 100.

Overall, the electrochemical hydrogen pump 100 according to this example has an anode support 60 between the anode gas diffusion layer 15 and the anode separator 17, and the relative magnitudes of the size L1 of the vent holes 61 along the transverse axis 200 of the anode gas flow channel 33 and the width L2 of the anode gas flow channel 33 are set so that the former is smaller than the latter (L1<L2). By virtue of this, the electrochemical hydrogen pump 100 according to this example is unlikely to suffer the situation of the porous carbon sheet 15S in the anode gas diffusion layer 15 being damaged by the differential pressure that occurs between the cathodes CA and anodes AN of the electrochemical hydrogen pump 100, compared with one wherein the size L1 of the vent holes 61 is larger than or equal to the width L2 of the anode gas flow channel 33 (L1≥L2).

If it is assumed that a vent hole 61 in the metal sheet 60S in the anode support 60 does not straddle an edge 33A of the anode gas flow channel 33 in the anode separator 17 but is present on a rib of the anode gas flow channel 33, furthermore, this vent hole 61 does not allow the hydrogen-containing gas through to be supplied to the anode gas diffusion layer 15. When the opposite is the case, or when a vent hole 61 in the metal sheet 60S straddles an edge 33A of the anode gas flow channel 33, this vent hole 61 allows the hydrogen-containing gas through to be supplied to the anode gas diffusion layer 15.

Hence the electrochemical hydrogen pump 100 according to this example, in which a subset of the multiple vent holes 61 straddles an edge 33A of the anode gas flow channel 33 is improved in terms of the diffusion of the hydrogen-containing gas from the anode gas diffusion layer 15 into the anode catalyst layer 13 compared with one wherein the same subset of vent holes 61 does not straddle an edge 33A of the anode gas flow channel 33 but lies on rib(s) of the anode gas flow channel 33.

Except for the described features, the electrochemical hydrogen pump 100 according to this example may be the same as the electrochemical hydrogen pump 100 according to Embodiment 1 or Example 1 of Embodiment 1.

### Example 3

An electrochemical hydrogen pump 100 according to Example 3 is the same as the electrochemical hydrogen pump 100 according to Embodiment 1 except that the porous carbon sheet 15S is a sheet of sintered carbon.

In general, sintered carbon is rigid compared with a compact given by mixing a powder of the carbon, for example with a resin, and setting or curing the mixture by drying. In particular, plastic-formed carbon (carbon-graphite composite with a resin) has high flexural strength.

Hence, for the electrochemical hydrogen pump 100 according this example, the anode gas diffusion layer 15 has an appropriate degree of flexural strength by virtue of the porous carbon sheet 15S being a sheet of sintered carbon.

Examples of sintered carbon materials include sintered masses of glassy carbon (glass-like carbon), diamond-like carbon (DLC), and plastic-formed carbon (PFC).

Except for the described features, the electrochemical hydrogen pump 100 according to this example may be the same as the electrochemical hydrogen pump 100 according to any of Embodiment 1 or Example 1 or 2 of Embodiment 1.

### Example 4

An electrochemical hydrogen pump 100 according to Example 4 is the same as the electrochemical hydrogen pump 100 according to Embodiment 1 except that there is an electrically conductive layer 70 on the surface of the anode support 60.

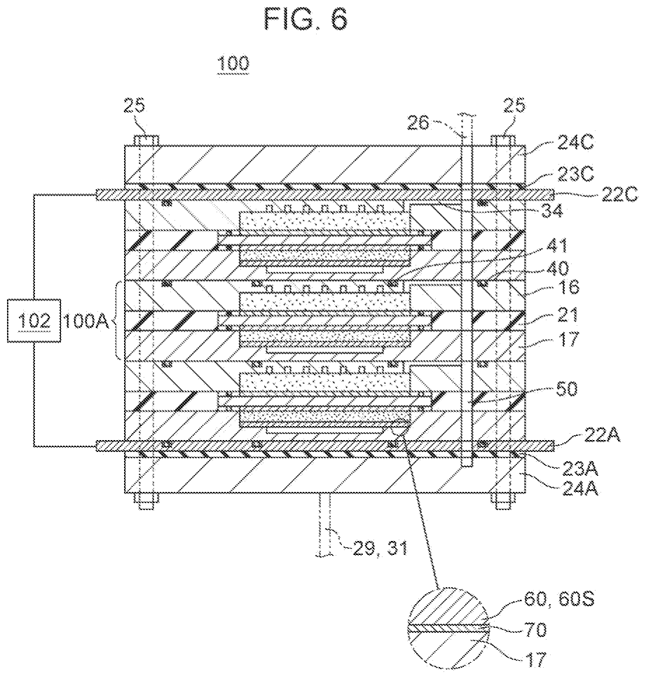

FIG. 6 is a diagram illustrating an example of an electrochemical hydrogen pump according to Example 4 of Embodiment 1.

On the surface of the metal sheet 60S in the anode support 60, the constituents of the metal sheet 60S may be oxidized, for example by atmospheric oxygen, to form an electrically non-conductive oxide film (passive film). If the metal sheet 60S is a stainless-steel element, for example of SUS316 or SUS316L, the passive film that forms on the surface of this metal sheet 60S contains chromium oxide, which is highly resistant to acids. The passive film hinders, for example, the electrical conduction between the anode support 60 and the anode separator 17 by increasing the contact resistance therebetween. Alternatively, the passive film hinders, for example, the electrical conduction between the anode support 60 and the anode gas diffusion layer 15 by increasing the contact resistance therebetween.

As such, the electrochemical hydrogen pump 100 according to this example has an electrically conductive layer 70 at right place(s) on the surface of the metal sheet 60S in the anode support 60 as illustrated in FIG. 6. The electrically conductive layer 70 has the desired acid resistance and electrical conductivity.

The electrically conductive layer 70 can be of any type as long as it has the desired acid resistance and electrical conductivity.

For example, the electrically conductive layer 70 may be a film of platinum, gold, or other noble metals formed by electroplating or electroless plating or may be a coating of a carbon material formed by spray coating.

Alternatively, the electrically conductive layer 70 can be obtained by, for example, extending a commercially available coating material using rollers, pressing the extended material into the desired size, and then joining this coating material to the surface of the metal sheet 60S by diffusion bonding.

Overall, the electrochemical hydrogen pump 100 according to this example has an electrically conductive layer 70 on the surface of the metal sheet 60S in the anode support 60, and this helps prevent the aforementioned increases in the contact resistance between elements well.

Except for the described features, the electrochemical hydrogen pump 100 according to this example may be the same as the electrochemical hydrogen pump 100 according to any of Embodiment 1 or Examples 1 to 3 of Embodiment 1.

### Embodiment 2

An electrochemical hydrogen pump 100 according to Embodiment 2 is the same as the electrochemical hydrogen pump 100 according to Embodiment 1 except that the anode support 60 is integral with the anode separator 17.

For example, the metal sheet 60S in the anode support 60 and the anode separator 17 may be integral with each other as a result of diffusion bonding.

By virtue of this, the electrochemical hydrogen pump 100 according to this embodiment has no space at the interface between the metal sheet 60S in the anode support 60 and the anode separator 17, and, therefore, the contact resistance therebetween is lower. In addition, the electrochemical hydrogen pump 100 according to this embodiment offers streamlined assembly of its hydrogen pump units 100A by virtue of the reduced number of components, if it is produced by stacking multiple hydrogen pump units 100A.

Except for the described features, the electrochemical hydrogen pump 100 according to this embodiment may be the same as the electrochemical hydrogen pump 100 according to any of Embodiment 1 or Examples 1 to 4 of Embodiment 1.

### Variation

An electrochemical hydrogen pump 100 according to a variation of Embodiment 2 is the same as the electrochemical hydrogen pump 100 according to Embodiment 1 except that the anode support 60 is integral with the anode gas diffusion layer 15.

For example, the integration of the anode support 60 and the anode gas diffusion layer 15 can be achieved by providing a suitable resin or other material (e.g., an ionomer) therebetween.

By virtue of this, the electrochemical hydrogen pump 100 according to this variation has a reduced number of components. The electrochemical hydrogen pump 100 according to this variation therefore offers streamlined assembly of its hydrogen pump units 100A, if it is produced by stacking multiple hydrogen pump units 100A.

Except for the described features, the electrochemical hydrogen pump 100 according to this variation may be the same as the electrochemical hydrogen pump 100 according to any of Embodiment 1, Examples 1 to 4 of Embodiment 1, or Embodiment 2.

### Embodiment 3

An electrochemical hydrogen pump 100 according to Embodiment 3 is the same as the electrochemical hydrogen pump 100 according to Embodiment 1 except for the structure of the anode support 160 and the anode separator 17, which is described below.

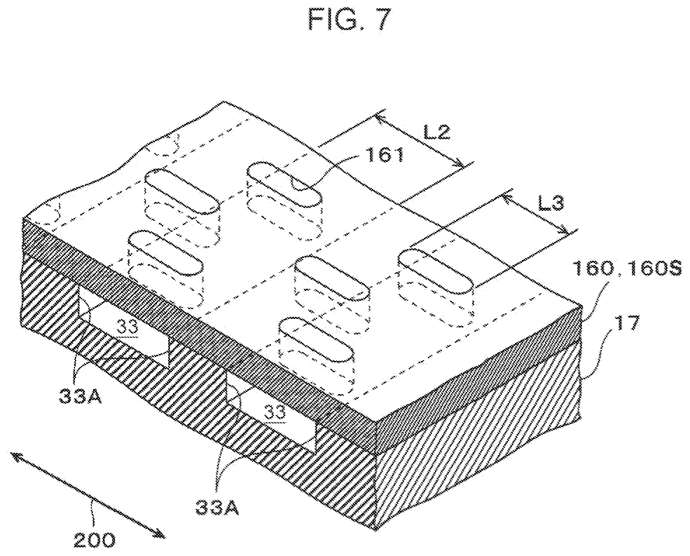

FIG. 7 is a diagram illustrating an example of an anode support and an anode separator in an electrochemical hydrogen pump according to Embodiment 3. FIG. 7 illustrates a perspective view of the metal sheet 160S in the anode support 160 and of the anode separator 17.

The metal sheet 160S is a metal element having multiple vent holes 161.

As illustrated in FIG. 7, the multiple vent holes 161 are elongated through holes created in the metal sheet 160S and having a track shape, in which the holes are formed by a pair of straight lines and a pair of semicircles.

The multiple vent holes 161 are arranged to be staggered in plan view. The straight stretches of the vent holes 161 extend parallel to the transverse axis 200 of the anode gas flow channel 33 in the anode separator 17. The major axis L3 of the vent holes 161 is smaller than the width L2 of the anode gas flow channel 33 (L3<L2).

Here, for the electrochemical hydrogen pump 100 according to this embodiment, the multiple vent holes 161 include vent holes 161 positioned to be inside a region facing a groove of the anode gas flow channel 33 and vent holes 161 part of which is in a region facing a rib of the anode gas flow channel 33.

The former vent holes 161 are present on a groove of the anode gas flow channel 33 without straddling an edge 33A of the anode gas flow channel 33. In the example illustrated in FIG. 7, there are three rows of vent holes 161, with the rows repeated perpendicular to the aforementioned axis 200, and the vent holes 161 in the front and third rows are positioned to be inside a region facing a groove of the anode gas flow channel 33.

The latter vent holes 161 straddle an edge 33A of the anode gas flow channel 33 in the anode separator 17. In the example illustrated in FIG. 7, the vent holes 161 in the second row are partially outside a region facing a groove of the anode gas flow channel 33: part of them is in a region facing a rib of the anode gas flow channel 33.

The advantages of the electrochemical hydrogen pump 100 according to this embodiment are not described. The advantages can be understood easily by referring to and considering those of the electrochemical hydrogen pump 100 according to Example 2 of Embodiment 1.

Except for the described features, the electrochemical hydrogen pump 100 according to this embodiment may be the same as the electrochemical hydrogen pump 100 according to any of Embodiment 1, Examples 1 to 4 of Embodiment 1, Embodiment 2, or the variation of Embodiment 2.

Embodiment 1, Examples 1 to 4 of Embodiment 1, Embodiment 2, the variation of Embodiment 2, and Embodiment 3 may be combined unless mutually exclusive.

To those skilled in the art, many improvements to and other embodiments of the present disclosure are apparent from the foregoing description. The foregoing description should therefore be construed only as an illustration and is provided in order to teach those skilled in the art the best mode of carrying out the present disclosure. The details of the structures and/or functions set forth herein can be substantially changed without departing from the spirit of the present disclosure.

For example, the MEAs, the anode separator 17, the anode support 60, etc., in the electrochemical hydrogen pumps 100 can also be applied to other compressors, such as water electrolyzers.

### INDUSTRIAL APPLICABILITY

An aspect of the present disclosure is applicable to compressors that can operate with less damage to a porous carbon sheet in their anode diffusion layer than known ones.

What is claimed is:

1. A compressor comprising:
an electrolyte membrane;
an anode catalyst layer in contact with a first primary surface of the electrolyte membrane;
a cathode catalyst layer in contact with a second primary surface of the electrolyte membrane;
an anode diffusion layer disposed on the anode catalyst layer and including a porous carbon sheet;
a cathode gas diffusion layer on the cathode catalyst layer;
an anode support disposed on the anode diffusion layer and including a metal sheet having a plurality of vent holes;
an anode separator disposed on the anode support and having, on a primary surface thereof closer to the anode support, a fluid flow channel through which an anode fluid flows; and
a voltage applicator that applies a voltage across the anode catalyst layer and the cathode catalyst layer,
the compressor producing compressed hydrogen by causing the voltage applicator to apply the voltage to move extracted protons from an anode fluid supplied to the anode catalyst layer to the cathode catalyst layer via the electrolyte membrane, wherein
flexural strength of the metal sheet is higher than flexural strength of the porous carbon sheet.

2. The compressor according to claim 1, wherein air permeance of the anode support along thickness thereof is greater than air permeance of the porous carbon sheet along thickness thereof.

3. The compressor according to claim 1, wherein a subset of the plurality of vent holes straddles an edge of the fluid flow channel.

4. The compressor according to claim 1, wherein a size of at least a subset of the plurality of vent holes along a transverse axis of the fluid flow channel is smaller than a width of the fluid flow channel.

5. The compressor according to claim 1, wherein the porous carbon sheet is a sheet of sintered carbon.

6. The compressor according to claim 1, wherein an electrically conductive layer is disposed on a surface of the anode support.

7. The compressor according to claim 1, wherein a thickness of the anode diffusion layer is larger than a thickness of the anode support.

8. The compressor according to claim 1, wherein the metal sheet is one metal steel plate.

9. The compressor according to claim 1, wherein the anode support is integral with the anode separator.

10. The compressor according to claim 1, wherein the anode support is integral with the anode diffusion layer.
